(19) United States
(12) Patent Application Publication
(10) Pub. No.: US 2006/0020862 A1
(43) Pub. Date: Jan. 26, 2006

(54) Apparatus for generating deterministic test pattern using phase shifter

(76) Inventors: Sung-Ho Kang, Seoul (KR); Dong-Sup Song, Seoul (KR)

Correspondence Address: Peter T. Kwon;G W i P S, Kangnam, P.O. Box 2301, Seoul, 135-242, KR

(21) Appl. No.: 10/896,197

(22) Filed: Jul. 20, 2004

(51) Int. Cl. G06F 11/00

(52) U.S. Cl. 714/726

(57) ABSTRACT

An apparatus for generating a deterministic test pattern is provided for a BIST having a scan chain, comprising the control bits storing devise for storing the number of a deterministic test pattern that is covered by a tap configuration; pattern counter devise for receiving the values stored in the control bits storing devise one by one and then counting the values backward; configuration counter devise for tracing the order of a current tap configuration and incrementing the order by 1 whenever the value of the pattern counter passes through 1; a decoder for constituting a phase shifting network depending on the value of the configuration counter devise and determining an input signal of an XOR gate depending on TapConnᵢ^{(j)}; and a reconfigurable phase shifter for receiving the input signal from the decoder to constitute an actual phase shifter.

### BACKGROUND OF THE INVENTION

1. Field of the Invention

The present invention relates to an apparatus for generating a deterministic test pattern for a built-in self-test (BIST) for a circuit having a scan chain.

2. Background of the Related Art

A BIST as one of Design For Testability (DFT) schemes is an effective technology in which functional blocks necessary for a test are logically designed and built in a chip, so that test dependency on an expensive external tester is lowered and cost needed for a test is thus significantly reduced.

In order for the BIST to have an economically effective value, it is necessary to meet requirements on several designs. These requirements may include overhead of an area occupied by test logic, electric power consumed upon a test, final fault coverage, the time taken to perform a test and the like.

Of them, the fault coverage and the test time are closely connected with each other. That is, the greater the number of a test pattern applied, the higher the fault coverage. In this case, however, a relatively long test time is required. On the contrary, if a small number of a test pattern is applied, only a short test time is needed. In this case, however, there is a problem in that the fault coverage is relatively lowered.

In a built-in self-test scheme, a deterministic test pattern is applied in order to solve these problems. In other words, a minimum test pattern that can accomplish high fault coverage is previously generated using an ATPG (Automatic Test Pattern Generation) program. Hardware that can generate a test pattern is designed using a pattern generator of a BIST to accomplish high fault coverage with only a short test length. This can be said an object of the deterministic BIST.

In conventional typical technology for a deterministic BIST for a circuit having a scan chain, there is used a method in which the output of a linear feedback shift register (hereinafter, referred to as “LFSR”) for generating a pseudorandom pattern is compared with a deterministic test pattern of each scan chain and possible interconnection between the output of the LFSR and each scan chain is reconfigured every test pattern, as shown in FIG. 1 (a deterministic BIST using reconfigurable interconnection).

For example, the above method can be performed as follows. It is first assumed that in FIG. 1, a circuit to be tested has four scan chains each of which has four scan cells. It is also assumed that a deterministic test pattern obtained through ATPG (Automatic Test Pattern Generation) for this circuit is like Table 1.

TABLE 1

| | Test | Test | Test | Test |
|---|---|---|---|---|
| | pattern 1 | pattern 2 | pattern 3 | pattern 4 |
| | (C1) | (C2) | (C3) | (C4) |
| Scan chain 1 | 00xx | 0xxx | xx11 | xx11 |
| Scan chain 2 | 1xx0 | xx1x | x10x | 1xxx |
| Scan chain 3 | 10xx | 01xx | x1x0 | 01xx |
| Scan chain 4 | x0xx | 11xx | 10xx | x001 |

If a LFSR having a characteristic polynomial x⁴+x³+1 is used and an initial value is 0001(x4 x3 x2 x1), the LFSR generates a pseudorandom pattern in order of those shown in FIG. 2.

A deterministic BIST scheme under conventional scan chain environment will be described in short. An interconnection network (see FIG. 1(b)) is constructed so that a LFSR output that satisfies a deterministic pattern among LSFR outputs generated as shown in FIG. 2 is connected to a corresponding scan chain. Its process is as follows.

In the initialization process, all the LFSR outputs are set as the output of the LFSR that can be connected to each scan chain. That is,
Conn₁⁽¹⁾={1, 2, 3, 4},
Conn₂⁽¹⁾={1, 2, 3, 4},
Conn₃⁽¹⁾={1, 2, 3, 4},
Conn₄⁽¹⁾={1, 2, 3, 4}. In this case, Connⱼ⁽ⁱ⁾, “i” indicates a configuration number and “j” designates a scan chain number.

All interconnection configurations that can generate a deterministic pattern are found from the previous Connⱼ⁽ⁱ⁾ while the LFSR generates a pseudorandom pattern P1. In this case, during the P1 period, a deterministic pattern c1 can be generated by the following interconnection configuration.
P1: c1
Conn₁⁽¹⁾={1, 4},
Conn₂⁽¹⁾={2},
Conn₃⁽¹⁾={2},
Conn₄⁽¹⁾={1, 4}

In the process of generating a LFSR pattern P2 from Connⱼ⁽ⁱ⁾ in previous steps, c3 can be generated and its result is as follows.
P2: c3
Conn₁⁽¹⁾={4},
Conn₂⁽¹⁾={2},
Conn₃⁽¹⁾={2},
Conn₄⁽¹⁾={1, 4}

In the process of generating a LFSR pattern P3 among Connⱼ⁽ⁱ⁾ so far, there is no deterministic pattern that can be generated by an interconnection configuration. Next, in the process of generating a LFSR pattern P4, a deterministic test pattern C2 can be generated and its result is as follows.
P4: c2
Conn₁⁽¹⁾={4},
Conn₂⁽¹⁾={2},
Conn₃⁽¹⁾={2},
Conn₄⁽¹⁾={1, 4}

This process is repeated until all the deterministic test patterns are generated.

The core of this conventional technology for generating the deterministic test pattern under the scan chain environment is to connect interconnections between the LFSR and the scan chain so that the output of each LFSR that generates a pseudorandom pattern can cover the deterministic test pattern needed for the scan chain.

However, this method has a problem that the length of a test pattern for obtaining constant fault coverage may be very long, if necessary. This fact can be found even in the aforementioned example. In the above example, during the time periods P1 and P2 of the LFSR, respective deterministic test patterns C1 and C3 can be generated. However, it can be seen that any deterministic test pattern is not covered during the time period P3. This is because when a deterministic test pattern that can be covered during an output time period of a current LFSR is found, a search space is limited to an interconnection configuration Connⱼ⁽ⁱ⁾ up to an output time period of the previous LFSR. An output time period of a LFSR that does not cover a deterministic test pattern will be further increased since the size of Connⱼ⁽ⁱ⁾ is reduced as time goes by.

In the prior art, due to these problems, a parameter “maxskippattern” is set. That is, if a new deterministic test pattern is not covered during a LFSR output period as much as the number set by the parameter “maxskippattern”, a current interconnection configuration is finished and the remaining deterministic test patterns are covered by a new interconnection configuration. Whenever a new interconnection configuration is set, Connⱼ⁽ⁱ⁾ is initialized as the outputs of all LFSRs. In other words, in the above example, Connⱼ⁽ⁱ⁾={1, 2, 3, 4} is initialized. Even in this case, however, the fixed number set by the parameter “maxskippattern” becomes the upper limit of a LFSR time period that does not cover a deterministic test pattern consecutively in a current interconnection configuration. There is still a problem in that a test time also increases.

### SUMMARY OF THE INVENTION

As a result of a research performed to resolve the above-mentioned problems, it came to a conclusion that a deterministic BIST that can accomplish a high fault coverage in a short test time under scan chain environment is possible by using a reconfigurable phase shifter. Accordingly, it is an object of the present invention to provide an apparatus for generating a deterministic test pattern wherein the principle of a phase shifter based on M-sequence as hardware that generates a deterministic test pattern is used.

To accomplish the above object, according to the present invention, there is provided an apparatus for generating a test pattern of a deterministic BIST for a circuit having a scan chain using a phase shifter, including: control bits storing means for storing the number of deterministic test patterns that are covered by a tap configuration; pattern counter means for receiving the values stored in the control bits storing means one by one and then counting the values backward; configuration counter means for tracing the order of a current tap configuration and incrementing the value of the configuration counter by 1 every time the value of the pattern counter passes through 1; a decoder for constituting a phase shifting network depending on the value of the configuration counter means and determining an input signal of an XOR gate depending on TapConnᵢ^{(j)}; and a reconfigurable phase shifter for receiving the input signal from the decoder to constitute an actual phase shifter.

### BRIEF DESCRIPTION OF THE DRAWINGS

Further objects and advantages of the invention can be more fully understood from the following detailed description taken in conjunction with the accompanying drawings in which:

FIG. 1 is a block diagram showing an apparatus for generating a deterministic test pattern under conventional scan chain environment;

FIG. 2 shows an exemplary pattern outputted from a LFSR (Linear Feedback Shift Register) shown in FIG. 1;

FIG. 3 is a flowchart illustrating a synthesis algorithm of a phase shifter according to the present invention;

FIGS. 4 to 6 show results every step that are obtained by performing the algorithm of FIG. 3;

FIG. 7 is a block diagram showing an apparatus for generating a deterministic test pattern according to the present invention.

FIG. 8 is a schematic per one scan chain of the deterministic test pattern generating apparatus according to the present invention.

FIG. 9 is a drawing explaining window property of M-sequence.

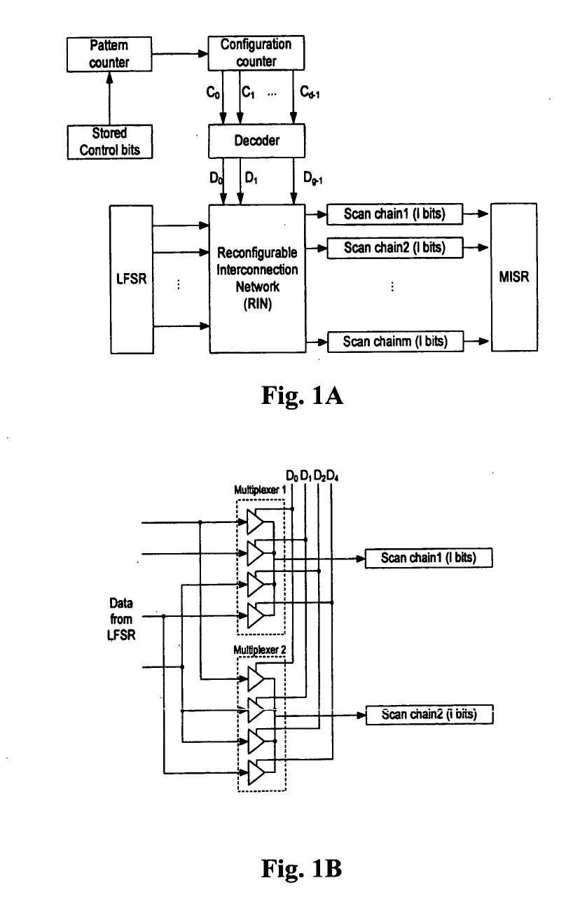

### DETAILED DESCRIPTION OF THE PREFERRED EMBODIMENT

The present invention will now be described in detail in connection with preferred embodiments with reference to the accompanying drawings.

1. Background of Theory

(1) Properties of M-sequence

In order to generate a deterministic test pattern in a scan chain, hardware proposed according to the present invention employs the following two properties (“Shift-and-Add properties” and “window properties”) of M (maximal)-sequence. The M-sequence refers to a sequence in which the number of patterns within one period, which are generated by an n-state LFSR, is 2ⁿ−1. This sequence occurs when a characteristic polynomial of the LFSR is primitive.

Shift-and-Add property: Let B be any M-sequence of length M=2^{m}−1, and “a” bit shift from B is Bₐ. If “a” is neither 0 nor a multiple of M, then the bitwise sum “B XOR Bₐ” is another shift B_{b} of B.

Window properties: It is assumed that a window of a width w slides along the M-sequence of the length 2^{m}−1. If w=m, every m-tuple is seen once, except that all zero m-tuple is not seen. More generally, if w=m−i, 0≦i≦m−1, every w-tuple is seen 2ⁱ times except that all zero w-tuple is seen 2ⁱ−1 times.

In the above, the window properties means that different sequences of 2ⁿ−1 in number except for all zeros can be produced when a window of n in length moves by M-sequence in the M-sequence of a n-stage LFSR. For example, in a LFSR having three stages as shown in FIG. 9, seven 3-bit sequences can be produced along the M-sequence. The present invention provides a method in which all windows that match a deterministic test pattern on the basis of a current LFSR are found from the M-sequence using the window properties and what degree the M-sequence has to be phase-shifted is calculated in order to produce these windows. In this case, the fact that all the deterministic test patterns can be produced regardless of a current LFSR state means that there exists at least one window that matches a deterministic test pattern since it is guaranteed that all bit sequences except for sequences being all zeros exist by means of the window properties.

(2) Phase Shifter

The phase shifter is a circuit block using the Shift-and-Add properties of the M-sequence. If each output sequence of a LFSR is intact applied to a scan path upon a test, there exists high correlation between neighboring scan chain patterns. This reduces fault coverage. In order to solve this problem, the phase shifter is used. A typical phase shifter is implemented using an XOR tree between a LFSR and CUT (Circuit under Test). Typical methods for designing the phase shifter may include a method using a transition matrix of a LFSR and a method using simulation. The method for designing the phase shifter using the transition matrix of the LFSR has a disadvantage that it requires lots of time since consecutive matrices have to be calculated. Meanwhile, the method for designing the phase shifter using simulation has an advantage that it can design the phase shifter within a short time using a logic simulator. The process for designing the phase shifter using simulation is as follows:
1) Determine a dual LFSR.
2) Initialize the dual LFSR to the values of 10 . . . 00
3) Simulate the dual LFSR for 2ⁿ−1−k clock cycles.
4) Read the resulting content of the dual LFSR: the locations of 1s will point out positions that should be included in a phase shifter structure to obtain a sequence shifted down by k bits.
   2. Description of the Present Invention

The present invention is based on a reconfigurable phase shifter in which a phase shifter between a LFSR and CUT varies has a different construction depending on a test pattern that will be applied to a scan chain.

(1) Synthesis Algorithm of Reconfigurable Phase Shifter

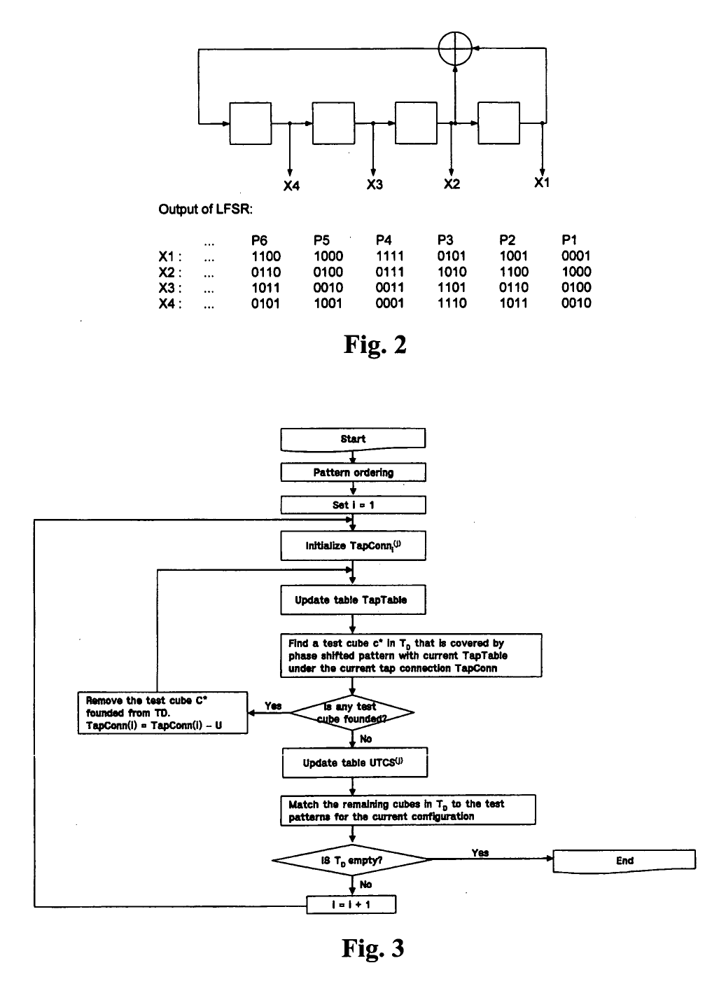

FIG. 3 shows an algorithm for synthesizing the reconfigurable phase shifter according to the present invention. The meaning of each step of the algorithm is as follows:

Pattern ordering: Reordering of deterministic test patterns by ATPG (Automatic Test Pattern Generation). In ordering, a sequence having a higher “don't-care” value (x) within one pattern comes first. This is for increasing the probability that several test patterns can share a single tap configuration.

Set i=1: “i” is a character that traces the number of a tap configuration.

Initialize TapConnᵢ^{(j)}: TapConnᵢ^{(j)} is a set having a possible phase shifting number in a current step. In the above, “i” indicates a configuration number and “j” designates a scan chain number. In the initialization process, TapConnᵢ^{(j)} is initialized to a set {1, 2, . . . , 2ⁿ−1} in case of an n-stage LFSR.

Update table TapTable: TapTable is a table in which a generated pattern related to a phase shifting number in a current step is stored. The first table is created by a phase shifter-generating algorithm using existing simulation. This table is updated every time a deterministic test pattern is embedded in a reconfigurable phase shifter. In the updating rules, in case of an n-stage LFSR, a shift column is fixed but only a pattern column is cyclically shifted upward. (see an example)

Find a test cube c* in T_{D} that is covered by a phase shifted pattern with current TapTable under the current tap connection TapConnᵢ^{(j)}: T_{D} refers to a deterministic test pattern set by ATPG. Therefore, this step is for determining whether a pattern of TapTable that matches a phase shifting number of a current TapConnᵢ^{(j)} is compatible with the test pattern T_{D}.

Remove the test cube C* founded from T_{D}. TapConnᵢ^{(j)}=TapConnᵢ^{(j)}−U: “U” refers to a set of a phase shifting number that does not cover a deterministic test pattern. Accordingly, this process is for removing a phase shifting number that does not cover a current deterministic test pattern from TapConnᵢ^{(j)} up to the previous step.

Update table UTCS^{(j)}: UTCS^{(j)} is a result of a tap position that is ORed in a bit unit by each scan chain, which corresponds to TapConnᵢ^{(j)} found up to a current step. The process of updating UTCS(J) is performed until a deterministic test pattern satisfying a current tap configuration does not exist. This is a process for selecting a phase shifting number whose number of 1 is a minimum as a result of the OR operation. At this time, the selected phase shifting number is the basis for selecting one of two or more phase shift numbers every scan chain, which are finally left in a current tap configuration. (see an example).

Match the remaining cubes in T_{D} to the test patterns for the current configuration: This is a process of removing already covered patterns from deterministic test patterns that remain before a current tap configuration process is finished.

### EXAMPLE

Hereinafter, an example to which the algorithm is actually applied will be described in order to facilitate understanding of the method according to the present invention. The object to be performed is as follows:
T_{D}={{1xx10x, 1x10xx, x1xx01}, {1x110x, 10xx11, 0101xx}, {0x1x0x, x1xxxx, x1xx0x}} (see Table 2)
LFSR: In case of a 6-stage using a characteristic polynomial x⁶+x+1

Test subject circuit: if a circuit has three scan chains each of which has six scan cells

TABLE 2

| | chain 1 | chain 2 | chain 3 |
|---|---|---|---|
| pattern 1 | 1xx10x | 1x10xx | x1xx01 |
| pattern 2 | 1x110x | 10xx11 | 0101xx |
| pattern 3 | 0x1x0x | x1xxxx | x1xx0x |

1) Pattern Ordering—Patterns having a higher number of x can be ordered like Table 3.

TABLE 3

| | chain 1 | chain 2 | chain 3 |
|---|---|---|---|
| pattern 1 | 0x1x0x | x1xxxx | x1xx0x |
| pattern 2 | 1xx10x | 1x10xx | x1xx01 |
| pattern 3 | 1x110x | 10xx11 | 0101xx |

2) i=1
3) Initialize TapConnᵢ^{(j)}
TapConn₁⁽¹⁾={1, 2, 3 . . . , 63}
TapConn₁⁽²⁾={1, 2, 3, . . . , 63}
TapConn₁⁽³⁾={1, 2, 3, . . . , 63}
   4) Update table TapTable

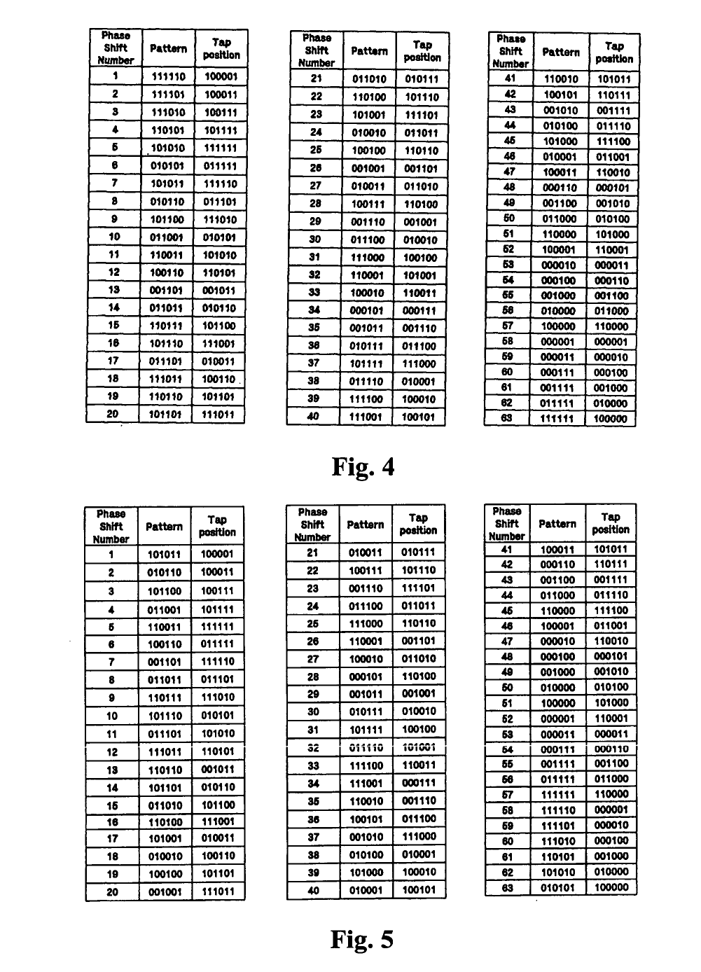

If a phase shifter-generating algorithm is performed by simulation, results as shown in FIG. 4 can be obtained. Respective columns of the tables shown in FIG. 4 indicate a phase shift number, a pattern and tap position.

5) Find a test cube c* in T_{D} that is covered by a phase shifted pattern with current TapTable under the current tap connection TapConnᵢ^{(j)}.

6) Remove the test cube C* found from T_{D}. TapConnᵢ^{(j)}=TapConnᵢ^{(j)}−U.

A current TapConnᵢ^{(j)} is
TapConn₁⁽¹⁾={1, 2, 3, . . . , 63}
TapConn₁⁽²⁾={1, 2, 3, . . . , 63}
TapConn₁⁽³⁾={1, 2, 3, . . . , 63}. In the above, if shift numbers that do not cover Pattern 1 are excluded, the following TapConnᵢ^{(j)} can be obtained.
TapConn₁⁽¹⁾={10, 13, 17, 26, 30, 49, 50, 55}
TapConn₁⁽²⁾={1, 2, 3, 4, 6, 8, 10, 11, 14, 15, 17, 18, 19, 21, 22, 24, 27, 30, 31, 32, 36, 38, 39, 40, 41, 44, 46, 50, 51, 56, 62, 63}
TapConn₁⁽³⁾={2, 4, 6, 10, 17, 22, 30, 31, 32, 39, 40, 44, 46, 50, 51, 56}
   7) Update table TapTable

As covered patterns are found previously, the TapTable table is updated (see FIG. 5). The updating rules are the same as those described above. FIG. 5 shows a phase shift table wherein 100000 is shifted as an initial value of a LFSR to produce a first pattern and a second pattern is produced when 011111 becomes the value of the LFSR.

8) Find a test cube c* in T_{D} that is covered by phase shifted pattern with current TapTable under the current tap connection TapConnᵢ^{(j)}.

9) Remove the test cube C* founded from T_{D}. TapConnᵢ^{(j)}=TapConnᵢ^{(j)}−U.

The phase shift number of TapConnᵢ^{(j)} that covers Pattern 2 is as follows.
chain1={3, 16, 19, 33, 36, 59, 61, 62}
chain2={1, 12, 17, 25, 34, 39, 60, 62}
chain3={4, 11, 26, 34, 40, 59, 61, 63}
   Intersection with a current TapConnᵢ^{(j)} is as follows.
TapConn₁⁽¹⁾={ }
TapConn₁⁽²⁾={1, 17, 39, 62}
TapConn₁⁽³⁾={4, 40}. In the above, as TapConn₁⁽¹⁾ is an empty set, it is impossible to embed Pattern 2 in the current tap configuration. Therefore, Pattern 3 is checked without updating TapConnᵢ^{(j)} and TapTable. A phase shift number of each chain in Pattern 3 is as follows.
Chain1={6, 9, 13, 22}
Chain2={1, 22, 31, 41}
Chain3={2, 30, 38, 63}
   Intersection with a current TapConnᵢ^{(j)} is as follows.
TapConn₁⁽¹⁾={13}
TapConn₁⁽²⁾={1, 22, 31, 41}
TapConn₁⁽³⁾={2, 30}
   10) Update table UTCS^{(j)}.

As there is no more pattern that matches a current tap configuration, UTCS^{(j)} is updated. The process of updating UTCS^{(j)} is a reference for selecting one of two or more phase shift numbers that exist in the current TapConnᵢ^{(j)}. As a result of existing “UTCS^{(j)} OR (tap position)”, a phase shift number whose number of 1 is a minimum is selected. Currently, UTCS is an initialization state.
UTCS⁽¹⁾={001011}
UTCS⁽²⁾:
If TapConn₁⁽²⁾ is 1, {100001}
If TapConn₁⁽²⁾ is 22, {101110}
If TapConn₁⁽²⁾ is 31, {100100}
If TapConn₁⁽²⁾ is 41, {101011}
If TapConn₁⁽²⁾ is 1 and 31, {100001} is selected (randomly among two) since the number of 1 is a minimum 2.
UTCS⁽³⁾:
If TapConn₁⁽³⁾ is 2, {100011}
If TapConn₁⁽³⁾ is 30, {010010}
If TapConn₁⁽³⁾ is 30, {010010} is selected since the number of 1 is a minimum 2.
   11) i=2
   12) Initialize TapConnᵢ^{(j)}.
TapConn₂⁽¹⁾={1, 2, 3, . . . , 63}
TapConn₂⁽²⁾={1, 2, 3, . . . , 63}
TapConn₂⁽³⁾={1, 2, 3, . . . , 63}
   13) Update table TapTable.

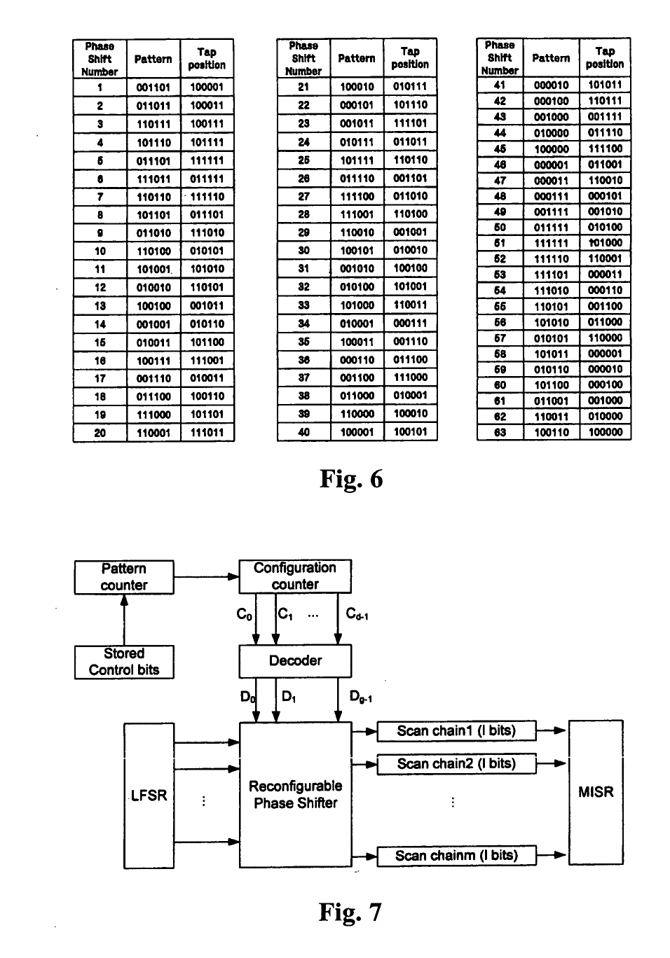

The TapTable table is updated. When 110101 becomes the value of a LFSR after a second pattern is generated, this table is a phase shift table for generating a third pattern (see FIG. 6).

14) Find a test cube c* in T_{D} that is covered by a phase shifted pattern with current TapTable under the current tap connection TapConnᵢ^{(j)}.

15) Remove the test cube C* found from T_{D}. TapConnᵢ^{(j)}=TapConnᵢ^{(j)}−U.

As the remaining deterministic test pattern is Pattern 2 only, Pattern 2 is checked.
Current TapConnᵢ^{(j)} is
TapConn₁⁽¹⁾={1, 2, 3, . . . , 63}
TapConn₁⁽²⁾={1, 2, 3, . . . , 63} and
TapConn₁⁽³⁾={1, 2, 3, . . . , 63}. In the above, if a shift number that does not cover Pattern 2 is excluded, the following TapConnⁱ^{(j)} can be obtained.
TapConn₂⁽¹⁾={8, 10, 13, 27, 30, 53, 55, 60}
TapConn₂⁽²⁾={1, 6, 11, 19, 28, 33, 54, 56, 58}
TapConn₂⁽³⁾={5, 20, 28, 34, 53, 55, 57, 61}
   16) Update table UTCS^{(j)}.

Next, since there is no more pattern that can be covered by current TapConnᵢ^{(j)}, a table UTCS^{(j)} is updated.

Since UTCS^{(J)} is not an initial state, one whose number of 1 is a minimum as a result of UTCS^{(J)} OR {tap position} is selected.
UTCS⁽¹⁾
When TapConn₂⁽¹⁾ is 8, UTCS⁽¹⁾={001011} OR {011101}={011111}
When TapConn₂⁽¹⁾ is 10, UTCS⁽¹⁾={001011} OR {010101}={011111}
When TapConn₂⁽¹⁾ is 13, UTCS⁽¹⁾={001011} OR {001011}={001011}
. . .
. . . One whose number of 1 is a minimum is selected.
UTCS⁽²⁾
When TapConn₂⁽²⁾ is 1, UTCS⁽²⁾={100001} OR {100001}={100001}
. . .
. . .
. . . One whose number of 1 is a minimum is selected.
UTCS⁽³⁾
When TapConn₂⁽³⁾ is 5, UTCS⁽³⁾={010010} OR {111111}={111111}
When TapConn₂⁽³⁾ is 20, UTCS⁽³⁾={010010} OR {111011}={111011}
. . .
. . .
. . .
When TapConn₂⁽³⁾ is 61, UTCS⁽³⁾={010010} OR {001000}={011010}
. . . One whose number of 1 is a minimum is selected.
   17) Since there is no more deterministic test pattern, the process is finished.

Through the above algorithm, two tap configurations were found so that the reconfigurable phase shifter can generate three deterministic test patterns. Its result is as follows:

In case of Configuration 1 (i=1), (Pattern 1, Pattern 3 cover)
TapConn₁⁽¹⁾={13}
TapConn₁⁽²⁾={1}
TapConn₁⁽³⁾={30}
   In case of Configuration 2 (i=2), (Pattern 2 cover)
TapConn₁⁽¹⁾={13}
TapConn₁⁽²⁾={1}
TapConn₁⁽³⁾={61}
UTCS^{(j)}:
UTCS(1): {001011}
UTCS(2): {100001}
UTCS(3): {011010}
   (2) Deterministic Test Pattern-Generating Hardware

Deterministic test pattern-generating hardware according to the present invention employs the results by the aforementioned synthesis algorithm of the reconfigurable phase shifter. For example, if the results by the above algorithm are as follows, logical BIST hardware can be generated as follows.

<Results that the Algorithm is Performed>

\textcircled{1} Total number of a tap configuration: 5
\textcircled{2} Configuration
   Configuration 1:
Deterministic pattern covered:
Pattern 1, Pattern 4, Pattern 5, Pattern 8 (4 in total)
Tap position
TapConn₁⁽¹⁾={001001}
TapConn₁⁽²⁾={010000}
TapConn₁⁽³⁾={000001}
   Configuration 2:
Deterministic pattern covered:
Pattern 2, Pattern 3, Pattern 11, Pattern 14, Pattern 19 (5 in total)
Tap position
TapConn₂⁽¹⁾={001000}
TapConn₂⁽²⁾={011000}
TapConn₂⁽³⁾={001001}
   Configuration 3:
Deterministic pattern covered:
Pattern 6, Pattern 10, Pattern 15 (3 in total)
Tap position
TapConn₃⁽¹⁾={100001}
TapConn₃⁽²⁾={010001}
TapConn₃⁽³⁾={100001}
   Configuration 4:
Deterministic pattern covered:
Pattern 7, Pattern 12, Pattern 16, Pattern 20 (4 in total)
Tap position
TapConn₄⁽¹⁾={001001}
TapConn₄⁽²⁾={010000}
TapConn₄⁽³⁾={000001}
   Configuration 5:
Deterministic pattern covered:
Pattern 9, Pattern 13, Pattern 17, Pattern 18 (4 in total)
Tap position
TapConn₅⁽¹⁾={101001}
TapConn₅⁽²⁾={010001}
TapConn₅⁽³⁾={001001}
\textcircled{3} UTCS
UTCS(1): {101001}
UTCS(2): {011001}
UTCS(3): {101001}
   <Hardware Construction>

An apparatus for generating a test pattern according to the present invention is shown in FIG. 7. Each block of FIG. 7 can be implemented as follows.
1) Stored Control bits block: This is implemented using a memory. This memory stores the number of deterministic test pattern that is covered by each tap configuration in. That is, in this case, values 4, 5, 3, 4 and 4 are sequentially stored in the memory.
2) Pattern counter: This is a counter that receives the values stored in the stored control bits block one by one and then backward counts them. In other words, if a value 4 is received from the stored control bits block, the counter counts backward a pattern applied to a scan chain in order of 4, 3, 2 and 1. If a counted value is 1, a next value of the stored control bits block is loaded.
3) Configuration counter: This is a counter that traces the order of a current tap configuration. That is, the value is incremented by 1 every time the value of the pattern counter passes through 1 starting from an initial value 1.
4) Decoder & reconfigurable phase shifter: This constitutes a phase shifting network depending on the value of the configuration counter. The decoder serves to determine an input signal of an XOR gate depending on TapConnᵢ^{(j)}). The reconfigurable phase shifter receives the input signal from the decoder to constitute an actual phase shifter.

For example, in the construction like the above <Result>, the decoder and the reconfigurable phase shifter for scan chain1 can be constructed as follows.

Decoder:

A combinational logic of

Input: 001 Output: 011
Input: 010 Output: 010
Input: 011 Output: 101
Input: 100 Output: 011
Input: 101 Output: 111.
   (In the above, the input is the output of the configuration counter and the output is the value of TapConnᵢ⁽¹⁾ corresponding to a 1 position of UTCS⁽¹⁾)
   Reconfigurable Phase Shifter:

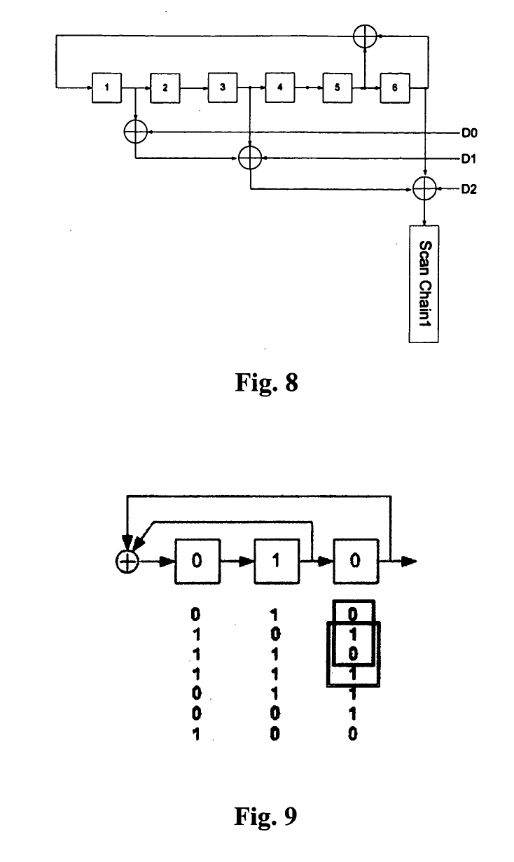

The reconfigurable phase shifter is a network having an XOR gate and is implemented using UTCS^{(j)}. For example, in case of UTCS⁽¹⁾: {101001}, a position where 1 exists is an output location of a LFSR that should be the input of the XOR gate. The output of the decoder is also the input of the XOR gate. The last output of the XOR tree is provided as a scan chain (see FIG. 8).

Generally, in case of a logical BIST that applies a deterministic test pattern, after a pseudorandom test pattern is applied to some degree, the deterministic test pattern has to be applied. In this case, both hardware for the pseudorandom BIST and the deterministic BIST must be provided. A phase shifter is hardware that is generally used in almost all the pseudorandom BIST. Therefore, using a phase shifter in a deterministic BIST is an area-efficient method since the same functional block is shared.

Furthermore, deterministic pattern-generating hardware according to the present invention employs window properties of M-sequence. It is thus possible to generate all the deterministic test patterns regardless of any LFSR patterns unlike an existing method. Therefore, it is expected that cost needed for a test can be significantly saved since necessary patterns can be generated within a short time period unlike the existing method.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. An apparatus for generating a test pattern of a deterministic BIST for a circuit having a scan chain using a phase shifter, comprising:
control bits storing means for storing the number of deterministic test patterns that are covered by a tap configuration;
pattern counter means for receiving the values stored in the control bits storing means one by one and then counting the values backward;
configuration counter means for tracing the order of a current tap configuration and incrementing the value of the configuration counter by 1 every time the value of the pattern counter passes through 1;
a decoder for constituting a phase shifting network depending on the value of the configuration counter means and determining an input signal of an XOR gate depending on TapConnᵢ^{(j)}; and
a reconfigurable phase shifter for receiving the input signal from the decoder to constitute an actual phase shifter.

2. The apparatus as claimed in claim 1, wherein the phase shifter is synthesized by the following steps of:
reordering deterministic test patterns through ATPG;
setting the number i of a tap configuration to 1;
initializing TapConnᵢ^{(j)} that is a set having a possible phase shifting number in a current step, wherein i indicates a configuration number and j designates a scan chain number;
updating a table TapTable in which a generated pattern related to the phase shifting number is stored in a current step;
determining whether a pattern of TapTable that matches the phase shifting number of a current TapConnᵢ^{(j)} is compatible with a test pattern T_{D};
removing phase shifting numbers that do not cover a current deterministic test pattern in TapConnᵢ^{(j)} up to the previous step;
updating an UTCS^{(j)} table which is a result of a tap position that is ORed in a bit unit by each scan chain, the tap position corresponding to TapConnᵢ^{(j)} found up to a current step, wherein the step of updating UTCS^{(j)} is performed until there exists no more deterministic test pattern that meets a current tap configuration; and
removing already covered patterns from deterministic test patterns that remain before a current tap configuration process is finished.

3. The apparatus as claimed in claim 2, wherein in the reordering order in the pattern-ordering step, a sequence having a higher “don't-care” value (x) within a single pattern comes first.

4. The apparatus as claimed in claim 2, wherein in the step of initializing TapConnᵢ^{(j)}, TapConnᵢ^{(j)} is initialized to a set of {1, 2, . . . , 2ⁿ−1} in case of an n-stage LFSR.

5. The apparatus as claimed in claim 2, wherein in the step of updating the table TapTable in which the generated pattern related to the phase shifting number is stored, the table is initially generated by a phase shifter-generating algorithm through existing simulation and is updated every time the deterministic test pattern is embedded in the reconfigurable phase shifter.
